(19) United States
(12) Patent Application Publication
(10) Pub. No.: US 2021/0340822 A1
(43) Pub. Date: Nov. 4, 2021

(54) METHODS OF FORMING COMPONENTS FOR EARTH-BORING TOOLS AND RELATED COMPONENTS AND EARTH BORING TOOLS

(71) Applicant: Baker Hughes Oilfield Operations LLC, Houston, TX (US)

(72) Inventors: Steven W. Webb, The Woodlands, TX (US); Eric C. Sullivan, Houston, TX (US)

(21) Appl. No.: 16/866,086

(22) Filed: May 4, 2020

(51) Int. Cl. E21B 10/567; C04B 35/532; C04B 35/622; C04B 35/645

(52) U.S. Cl. CPC E21B 10/5673; C04B 35/532; E21B 10/5735; C04B 35/645; C04B 35/62222

(57) ABSTRACT

A method of forming a superabrasive component for an earth-boring tool comprises disposing a first volume of particulate superabrasive material on a surface of a base structure. A first carbon-containing precursor material is deposited onto the first volume of unbonded particulate superabrasive material. An energy beam is directed onto the first carbon-containing precursor material to form a first volume of bonded polycrystalline superabrasive material having carbon-carbon atomic bonds between adjacent particles of the first volume of particulate superabrasive material. The method may be repeated to form a superabrasive component with multiple volumes of bonded polycrystalline superabrasive material. Additional methods of forming a superabrasive component, a superabrasive component, and an earth-boring tool are also described.

### TECHNICAL FIELD

Embodiments of the disclosure relate to methods of forming superabrasive components for use in earth-boring tools, to superabrasive components that may be formed by such methods and to earth boring tools equipped with such superabrasive components. More particularly, embodiments of the disclosure relate to methods of forming superabrasive components by additive manufacturing techniques involving energy beam sintering of unbonded material, to superabrasive components formed thereby and to earth boring tools equipped with such superabrasive components.

### BACKGROUND

Earth-boring tools for forming wellbores in subterranean formations may include cutting elements secured to a body. For example, a fixed-cutter earth-boring rotary drill bit (“drag bit”) may include cutting elements fixedly attached to a bit body thereof. As another example, a roller cone earth-boring rotary drill bit may include cutting elements in the form of so-called “inserts” secured to rotatable members (e.g., cones) mounted on bearing pins extending from legs of a bit body. Other examples of earth-boring tools utilizing cutting elements include, but are not limited to, core bits, bi-center bits, eccentric bits, hybrid bits (e.g., rolling components in combination with fixed cutting elements), reamers, and casing milling tools.

The cutting elements used in such earth-boring tools often include superabrasive material in the form of a volume (i.e., table) of polycrystalline diamond (“PCD”) material in the form of a polycrystalline diamond compact (PDC) on a substrate. In a fixed-cutter bit, a cutting edge and adjacent cutting face of the PDC table of each cutting element act to shear material from a subterranean formation being drilled or reamed. In a roller cone bit, inserts capped with a PDC act to gouge, scrape and crush subterranean formation material.

PCD material is material comprising interbonded grains or crystals of diamond material. In other words, PCD material includes direct, inter-granular bonds between the grains or crystals of diamond material. The terms “grain” and “crystal” are used synonymously and interchangeably herein.

PDC cutting elements are generally formed by sintering and bonding together relatively small diamond (synthetic, natural or a combination) grains, termed “grit,” under conditions of high temperature and high pressure in the presence of a Group VIII catalyst (e.g., cobalt, iron, nickel, or alloys and mixtures thereof) to form a PDC table. These processes are often referred to as high temperature/high pressure (or “HTHP”) processes. The supporting substrate may comprise a cermet material (i.e., a ceramic-metal composite material) such as, for example, cobalt-cemented tungsten carbide. In some instances, the PDC table may be formed on a substrate, for example, during the HTHP process. In such instances, catalyst material (e.g., cobalt) in the substrate may be “swept” into the diamond grains during sintering and serve as a catalyst material for forming the diamond table from the diamond grains and bonding the diamond table to the substrate. Powdered catalyst material may also be mixed with the diamond grains prior to sintering the grains together in an HTHP process. In other methods, the diamond table may be formed separately from the substrate and subsequently attached thereto. In all such instances using a conventional Group VIII catalyst material limits the temperature to which the PDC table, and specifically the cutting face and cutting edge, may experience during use before the residual catalyst in the diamond table stimulates back-graphitization of the diamond material. Conventionally, catalyst is removed, for example by acid leaching, from all or part of (i.e., the cutting face, cutting edge and to a depth into the PDC table. However, the leaching process is time-consuming, employs harsh chemicals (i.e., acids) at elevated temperatures, and if not carefully implemented, may result in irregularities in the depth of removal of the catalyst from the PDC table.

In addition, in some instances it is desirable to form a PDC table in shapes more complex than the conventional, substantial disc-shaped PDC in widespread use for subterranean drilling. While it is possible to form, for example, a domed-shaped PDC table or a recess in the PDC table cutting face during formation, and to form a radiused or chamfered cutting edge by machining after formation of the table, it is impractical from a yield and expense standpoint to form much more complex shapes by machining due to the hardness and relative fragility of the PDC table under tensile stress. Similarly, while it is possible to form a layered PDC table with, for example, different diamond grain sizes in different layers, it is difficult to maintain clean, uniform boundaries between the layers due to difficulties in loading the different levels of different sized diamond grains in the cartridge used to form the PDC table. Further, conventional processes make it difficult if not impossible to form PDC tables with more complex internal geometries. Finally, the requirement that the PDC table be formed in an HTHP press requires substantial capital equipment investment, and is time-consuming. The expense and production time is further increased if the PDC table is to be leached.

### BRIEF SUMMARY

Embodiments of the disclosure include a method of forming a superabrasive component for an earth-boring tool, the method comprising disposing a first level of a first volume of unbonded particulate superabrasive on a surface of a base structure, depositing a first carbon-containing precursor material onto the first level, and directing an energy beam onto the first carbon-containing precursor material to form a first level of a first volume of bonded polycrystalline superabrasive material having carbon-carbon atomic bonds between adjacent particles. The disposing, depositing and directing is repeated to form the first level of the first volume of bonded polycrystalline superabrasive material to complete the first volume of bonded superabrasive material, followed by disposing a first level of at least a second volume of unbonded particulate superabrasive material on the first volume of bonded polycrystalline superabrasive material, depositing a second carbon-containing precursor material onto the first level of the at least a second volume of particulate superabrasive material and directing an energy beam onto the second carbon-containing precursor material to form a first level of at least a second volume of bonded polycrystalline superabrasive material having carbon-carbon atomic bonds between adjacent particles and to bond with carbon-carbon atomic bonds particles of the first level of the second volume of bonded polycrystalline superabrasive material to an uppermost level of the first volume of bonded polycrystalline superabrasive material. The disposing, depositing and directing is repeated to form the first level of the second volume of bonded polycrystalline superabrasive material to complete the at least a second volume of bonded superabrasive material.

Embodiments of the disclosure include a method, using an additive manufacturing apparatus, of forming a PDC table for a cutting element for an earth-boring tool, the method comprising disposing a layer of unbonded particulate diamond material including unbonded diamond particles on a surface of a base structure, depositing a carbon-containing precursor material onto the layer of unbonded particulate diamond material, and directing a laser beam onto the first carbon-containing precursor material to form a first level of bonded polycrystalline diamond material having carbon-carbon atomic bonds between adjacent particles. The method further comprises disposing at least another layer of unbonded particulate diamond material on the first level of bonded polycrystalline diamond material, depositing the carbon-containing precursor material onto the at least another layer of particulate diamond material, and directing a laser beam onto the carbon-containing precursor material to form at least a second level of bonded polycrystalline diamond material having carbon-carbon atomic bonds between adjacent particles thereof and to particles of the first level of bonded polycrystalline diamond material.

Embodiments of the disclosure include a superabrasive component for an earth-boring tool comprising a substrate and a PDC table secured to the substrate and comprising diamond particles mutually bonded by carbon-carbon bonds, wherein the PDC table is entirely devoid of any catalyst.

### BRIEF DESCRIPTION OF THE DRAWINGS

FIG. 1 is a partial cut-away perspective view of an embodiment of a superabrasive component, in accordance with an embodiment of the disclosure;

FIG. 2 is a partial cut-away perspective view of an embodiment of a superabrasive component, in accordance with an embodiment of the disclosure;

FIG. 3 is a simplified side view of a process of forming a superabrasive component, in accordance with an embodiment of the disclosure;

FIG. 4 is a simplified side view of a process of forming a superabrasive component, in accordance with an embodiment of the disclosure;

FIG. 5 is a simplified side view of a process of forming a superabrasive component, in accordance with an embodiment of the disclosure;

FIG. 6 is a simplified side view of a process of forming a superabrasive component, in accordance with an embodiment of the disclosure;

FIG. 7 is a simplified side view of a process of forming a superabrasive component, in accordance with an embodiment of the disclosure;

FIG. 8 is a simplified side view of a process of forming a superabrasive component, in accordance with an embodiment of the disclosure;

FIG. 9 is a simplified cross-sectional view illustrating how a microstructure of a superabrasive component of either FIG. 2 or 6 may appear under magnification;

FIG. 10 is a simplified cross-sectional view illustrating how a microstructure of a superabrasive component of either FIG. 5 or 8 may appear under magnification;

FIG. 11 is a simplified cross-sectional view illustrating how the superabrasive component of FIG. 1 or 8 may be formed to have regions with at least one different characteristic, in accordance with an embodiment of the disclosure;

FIG. 12 is a simplified cross-sectional view illustrating how the superabrasive component of FIG. 1 or 8 may be formed to have regions with at least one different characteristic, in accordance with another embodiment of the disclosure;

FIG. 13 is a top cross-sectional view illustrating how the superabrasive component of FIG. 1 or 8 may be formed to have regions with at least one different characteristic, in accordance with an embodiment of the disclosure;

FIG. 14 is a top cross-sectional view illustrating how the superabrasive component of FIG. 1 or 8 may be formed to have regions with at least one different characteristic, in accordance with another embodiment of the disclosure;

FIG. 15 is a top cross-sectional view illustrating how the superabrasive component of FIG. 1 or 8 may be formed to have regions with at least one different characteristic, in accordance with another embodiment of the disclosure;

FIGS. 16 through 20 are views of additional embodiments of superabrasive components according to embodiments of the disclosure; and

FIG. 21 is a perspective view of an embodiment of an earth-boring tool including a superabrasive component of the disclosure.

### DETAILED DESCRIPTION

The high hardness and relative brittleness under tensile stress, as well as susceptibility to heat-induced degradation of conventional superabrasive (i.e., diamond) material in the form of a PDC may make it difficult to machine surfaces of the material to a desired nonplanar shape. As a result, it may be challenging to create superabrasive cutting tables with desired, particularly somewhat complex geometries and material properties to improve reliability, durability, and/or performance in the PDC cutting elements during use and operation.

Accordingly, it may be desirable to have methods of forming superabrasive (i.e., PDC) components for use in earth-boring tools while eliminating the need to machine the superabrasive material to shape one or more of the cutting face, cutting edge or side surface of the component to desired geometries. Additionally, it may be desirable to have methods of forming superabrasive components for use in earth-boring tools having multiple internal regions of various shapes and complexities, wherein one or more of the regions may exhibit different properties than one or more other regions. Such methods of forming superabrasive components may result in superabrasive cutting elements with desired internal and external geometries for use in earth-boring tools to enhance one or more of cutting efficiency, quality of the cutting table, durability of the cutting table, and performance of the superabrasive cutting elements during use and operation as compared to conventional superabrasive cutting elements for earth-boring tools. In addition, it may be desirable to form superabrasive components in the form of PDC tables which, as formed, are devoid of any catalyst (i.e., Group VIII metal) which might stimulate back-graphitization at temperatures in excess of about 900° C., which do not exhibit the porosity of leached PDC tables, and which do not require the use of HTHP processing to form.

Methods of forming superabrasive components for earth-boring tools are described, as are the superabrasive components for earth-boring tools, and earth-boring tools so equipped. In some embodiments, a method of forming a superabrasive component for an earth-boring tool comprises disposing a first volume of unbonded particulate superabrasive (i.e., diamond) material on a surface of a base structure, such as a substrate or a platen. A first volume of carbon-containing precursor material may be deposited onto the first volume of unbonded particulate superabrasive material. An energy beam may be directed onto the first volume of carbon-containing precursor material in a selected pattern or patterns in the X-Y plane to form a first volume of bonded polycrystalline superabrasive material having carbon-carbon atomic bonds between adjacent particles of the first volume of particulate superabrasive material. The first volume of bonded polycrystalline superabrasive material may have an exposed outer surface. A second volume of unbonded particulate superabrasive material may be disposed on the first volume of bonded polycrystalline superabrasive material. A second volume of carbon-containing precursor material may be deposited onto the second volume of unbonded particulate superabrasive material. An energy beam may be directed in a selected pattern or patterns onto the second volume of carbon-containing precursor material to form a second volume of bonded polycrystalline superabrasive material having carbon-carbon atomic bonds between adjacent particles of the second volume of particulate superabrasive material and between particulate superabrasive material of the first and second volumes The second volume of bonded polycrystalline superabrasive material may have an exposed outer surface. The foregoing process may be repeated, with additional volumes of unbonded particulate superabrasive material and carbon-containing precursor material until a superabrasive component in the form of a PDC table of a desired shape and size, and entirely devoid of any catalyst, is formed.

The methods of the disclosure may enable forming superabrasive components for earth-boring tools that have desired internal and external geometries and various combinations of properties while simultaneously eliminating the need to machine superabrasive material or to form the superabrasive components in conventional high temperature, high pressure processes. Accordingly, the methods of the disclosure may increase one or more of the quality, reliability, durability, and performance of the resulting PDC cutting element and an earth-boring tool including same, as compared to PDC cutting elements formed by conventional methods.

The following description provides specific details, such as specific shapes, specific sizes, specific material compositions, and specific processing conditions, in order to provide a thorough description of embodiments of the present disclosure. However, a person of ordinary skill in the art will understand that the embodiments of the disclosure may be practiced without necessarily employing these specific details. Embodiments of the disclosure may be practiced in conjunction with conventional fabrication techniques employed in the industry. In addition, the description provided below does not form a complete process flow for manufacturing a cutting element or an earth-boring tool. Only those process acts and structures necessary to understand the embodiments of the disclosure are described in detail below. Additional acts to form a complete cutting element or a complete earth-boring tool from the structures described herein may be performed by conventional fabrication processes.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “comprising,” “including,” “containing,” and grammatical equivalents thereof are inclusive or open-ended terms that do not exclude additional, unrecited elements or method steps, but also include the more restrictive terms “consisting of” and “consisting essentially of” and grammatical equivalents thereof. As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features, and methods usable in combination therewith should or must be excluded.

As used herein, the terms “longitudinal”, “vertical”, “lateral,” and “horizontal” are in reference to a major plane of a base structure (e.g., base material, base construction, substrate, etc.) in or on which one or more structures and/or features are formed and are not necessarily defined by earth's gravitational field. A “lateral” or “horizontal” direction is a direction that is substantially parallel to the major plane of the base structure, while a “longitudinal” or “vertical” direction is a direction that is substantially perpendicular to the major plane of the base structure. The major plane of the base structure is defined by a surface of the substrate having a relatively large area compared to other surfaces of the base structure.

As used herein, spatially relative terms, such as “beneath,” “below,” “lower,” “bottom,” “above,” “over,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “over” or “above” or “on” or “on top of” other elements or features would then be oriented “below” or “beneath” or “under” or “on bottom of” the other elements or features. Thus, the term “over” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, the term “configured” refers to a size, shape, material composition, orientation, and arrangement of one or more of at least one structure and at least one apparatus facilitating operation of one or more of the structure and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

As used herein, the terms “earth-boring tool” and “earth-boring drill bit” mean and include any type of bit or tool used for drilling during the formation or enlargement of a wellbore in a subterranean formation and include, for example, fixed-cutter bits, roller cone bits, percussion bits, core bits, eccentric bits, bi-center bits, reamers, mills, drag bits, hybrid bits (e.g., rolling components in combination with fixed cutting elements), and other drilling bits and tools known in the art.

As used herein, the term “polycrystalline material” means and includes any material comprising a number of grains or crystals of the material that are bonded together. The crystal structures of the individual grains of the material may be randomly oriented in space within the polycrystalline material. Non-limiting examples of polycrystalline material structures include polycrystalline diamond in the form of polycrystalline diamond formed of synthetic diamond crystals, polycrystalline diamond formed of natural diamond crystals, and polycrystalline material structures formed of combinations of natural and synthetic diamond comprising diamond grains directly bonded together by carbon-to-carbon bonds.

As used herein, the terms “inter-granular bond” and “carbon-carbon bond” mean and include any direct atomic bond between atoms in adjacent grains of superabrasive material.

As used herein, the term “superabrasive material” means and includes any material having a Knoop hardness value of greater than or equal to about 3,000 Kgf/mm² (29,420 MPa). Non-limiting examples of superabrasive materials include diamond (e.g., natural diamond, synthetic diamond, or combinations thereof).

As used herein, the term “sintering” means temperature driven mass transport, which may include densification and/or coarsening of a particulate component, and typically involves removal of at least a portion of the pores between the starting particles combined with coalescence and bonding between adjacent particles.

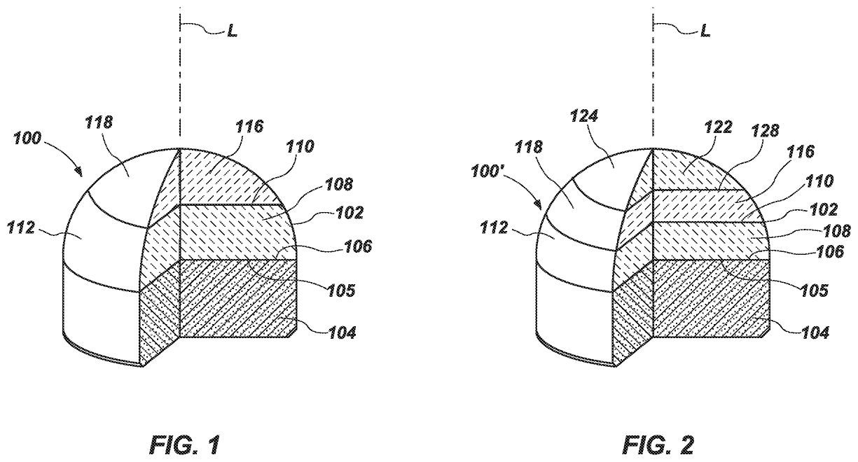

FIG. 1 illustrates a superabrasive component in the form of a cutting element 100 in accordance with embodiments as disclosed herein. The cutting element 100 includes a bonded polycrystalline superabrasive table 102 attached to a surface 105 of a base structure in the form of a supporting substrate 104 at an interface 106. Surface 105, and thus interface 106, may be substantially planar as depicted, or may have a more complex, three-dimensional geometry, as is known to those of ordinary skill in the art. In some embodiments, the bonded polycrystalline superabrasive table 102 may be secured (e.g., attached, bonded, etc.) to the substrate 104 at the interface 106 as the bonded polycrystalline superabrasive table 102 is being formed. In other embodiments, the bonded polycrystalline superabrasive table 102 may be formed separately from the substrate 104 and attached subsequently. In additional embodiments, the bonded polycrystalline superabrasive table 102 may comprise a first volume of bonded polycrystalline superabrasive material 108 and a second volume of bonded polycrystalline superabrasive material 116 separated by an interface 110. The first volume of bonded polycrystalline superabrasive material 108 may have an exposed outer surface 112. The second volume of bonded polycrystalline superabrasive material 116 may also have an exposed outer surface 118 contiguous with the exposed outer surface 112 of the first volume of bonded polycrystalline superabrasive material 108.

The bonded polycrystalline superabrasive table 102 may exhibit an exterior shape defined by a combination of the exposed outer surface 112 of the first volume of bonded polycrystalline superabrasive material 108 and the contiguous exposed outer surface 118 of the second volume of bonded polycrystalline superabrasive material 116. The first volume of bonded polycrystalline superabrasive material 108 and the second volume of bonded polycrystalline superabrasive material 116 may, in combination, be formed in an arrangement such that exposed outer surface 112 and exposed outer surface 118 together form a nonplanar surface, as shown. By way of non-limiting example, the nonplanar surface may exhibit a chisel shape, a frustoconical shape, a conical shape, a dome shape, an elliptical cylinder shape, a rectangular cylinder shape, a circular cylinder shape, a pyramidal shape, a frustopyramidal shape, a fin shape, a pillar shape, a stud shape, a truncated version of one of the foregoing shapes, or a combination of two or more of the foregoing shapes. Accordingly, the cross-sectional area of different horizontal levels of the first volume of bonded polycrystalline superabrasive material 108 perpendicular to a longitudinal axis L of cutting element 100 may be different and of different shapes. Likewise, the cross-sectional area of different horizontal levels of the second volume of bonded polycrystalline superabrasive material 116 perpendicular to a longitudinal axis L of cutting element 100 may be different and of different shapes. Further, the various horizontal levels of the first volume of bonded polycrystalline superabrasive material may be the same or different than the various horizontal levels of the second volume of horizontal material. The bonded polycrystalline superabrasive table 102 may be formed by a process described below.

In some embodiments, the first volume of bonded polycrystalline superabrasive material 108 may have the same material properties as the second volume of bonded polycrystalline superabrasive material 116. In other embodiments, the first volume of bonded polycrystalline superabrasive material 108 may have different material properties than those of the second volume of bonded polycrystalline superabrasive material 116. As non-limiting examples, the first volume of bonded polycrystalline superabrasive material 108 may comprise natural diamond particles, synthetic diamond particles, or a combination of natural diamond particles and synthetic diamond particles. Additionally, the second volume of bonded polycrystalline superabrasive material 116 may comprise natural diamond particles, synthetic diamond particles, or a combination of natural diamond particles and synthetic diamond particles.

In embodiments, the base structure as described above may be a substrate 104 for a cutting element. In additional embodiments, the base structure may be a portion of an external surface of an earth-boring tool 176 (FIG. 21). The base structure in the form of a substrate 104 may have any desired lateral cross sectional shape including, but not limited to, an elliptical shape, a circular shape, a tetragonal shape (e.g., square, rectangular, trapezium, trapezoidal, parallelogram, etc.), a triangular shape, a semicircular shape, an ovular shape, a semicircular shape, a tombstone shape, a tear drop shape, a crescent shape, or a combination of two or more of the foregoing shapes. The peripheral shape substrate 104 may be symmetric, or may be asymmetric. In some embodiments, the substrate 104 exhibits a non-axis-symmetrical shape, such that a shape of a portion of a surface of the substrate 104 extending away from a central axis of the substrate 104 in one lateral direction (e.g., the X-direction) is different than a shape of another portion of a surface of the substrate 104 extending away the central axis of the substrate 104 in another lateral direction (e.g., the Y-direction).

The substrate 104 may be formed of and include a material that is relatively hard and resistant to wear. By way of non-limiting example, the substrate 104 may be formed from and include a ceramic-metal composite material (also referred to as a “cermet” material). In some embodiments, the substrate 104 is formed of and includes a cemented carbide material, such as a cemented tungsten carbide material, in which tungsten carbide particles are cemented together by a metallic binder material. As used herein, the term “tungsten carbide” means any material composition that contains chemical compounds of tungsten and carbon, such as, for example, WC, W₂C, and combinations of WC and W₂C. Tungsten carbide includes, for example, cast tungsten carbide, sintered tungsten carbide, and macrocrystalline tungsten carbide. Unlike the case in conventional substrates, the metallic binder material may be devoid of a metal-solvent catalyst material. If such catalyst material is present, such a substrate may be formed with, or coated with, a barrier material layer on a surface of the substrate 104 to which the bonded polycrystalline superabrasive table 102 is bonded. In the latter instance, the barrier material prevents migration, or sweep, of catalyst material from substrate 104 into superabrasive table, preventing temperature-limiting contamination thereof.

FIG. 2 illustrates additional embodiments of a superabrasive component 100′ shown in FIG. 1. Referring to FIG. 2, the volume of bonded polycrystalline superabrasive table 102 may comprise at least one additional volume of bonded polycrystalline superabrasive material 122 bonded to a surface of the second volume of bonded polycrystalline superabrasive material 116 at an interface 128. The at least one additional volume of bonded polycrystalline superabrasive material 122 may have an exposed outer surface 124 contiguous with outer surface 118 of the second volume of bonded polycrystalline superabrasive material 116. The cross-sectional area of different horizontal levels of the at least one additional volume of bonded polycrystalline superabrasive material 116 perpendicular to a longitudinal axis L of cutting element 100′ may be different and of different shapes. Such cross-sectional area may also be different and of different shapes than the cross-sectional areas and shapes of horizontal levels of each of the first and second volumes 108, 116 of bonded polycrystalline superabrasive material. The bonded polycrystalline superabrasive table 100′ may exhibit an exterior shape defined by a combination of the exposed outer surface 112 of the first volume of bonded polycrystalline superabrasive material 108, the contiguous exposed outer surface 118 of the second volume of bonded polycrystalline superabrasive material 116 and the contiguous exposed outer surface 124 of the at least one additional volume of bonded polycrystalline superabrasive material 122. The first volume of bonded polycrystalline superabrasive material 108, the second volume of bonded polycrystalline superabrasive material 116, and the at least one additional volume of bonded polycrystalline superabrasive material 122 may, in combination, be formed in an arrangement such that exposed outer surface 112, exposed outer surface 118, and exposed outer surface 124 together form a nonplanar surface. By way of non-limiting example, the nonplanar surface may exhibit a chisel shape, a frustoconical shape, a conical shape, a dome shape, an elliptical cylinder shape, a rectangular cylinder shape, a circular cylinder shape, a pyramidal shape, a frustopyramidal shape, a fin shape, a pillar shape, a stud shape, a truncated version of one of the foregoing shapes, or a combination of two or more of the foregoing shapes. Accordingly, the cross-sectional areas of different levels of the first volume of bonded polycrystalline superabrasive material 108 may be different from each other, and/or from both the cross-sectional areas of different levels of the second volume of bonded polycrystalline superabrasive material 116, and the at least one cross-sectional area of different levels of the at least one additional volume of bonded polycrystalline superabrasive material 122. The bonded polycrystalline superabrasive table 102 may be formed by a process described in detail below.

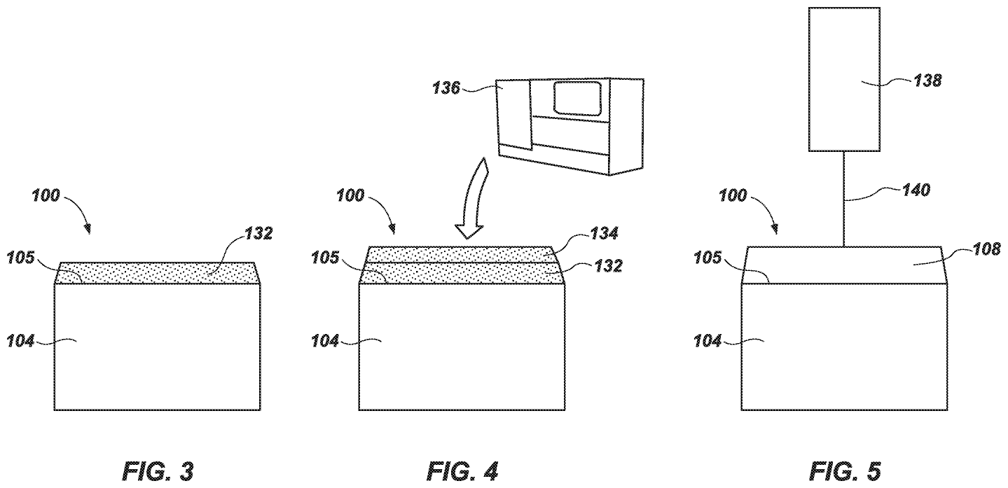

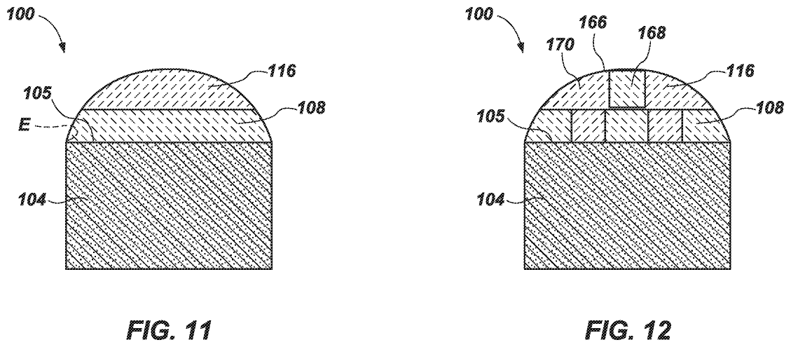

With reference to FIGS. 3-8 a method of forming a superabrasive component for an earth-boring tool will now be described. FIG. 3 illustrates disposing a first level of a first volume of unbonded particulate superabrasive material 132 on the surface 105 of a substrate 104. The first level may be a number of grains thick of the unbonded particulate superabrasive material 132, for example a level thickness of two to ten times an average grain diameter for five micron diameter grains. The thickness value may be influenced by the size of the diamond grains, deposition constraints of the equipment in the form of an additive manufacturing apparatus 136 used to deposit the material, and the extend of localized heating obtainable by the energy beam utilized in a sintering process as subsequently described. In some embodiments, the first volume of unbonded particulate superabrasive material 132 may comprise natural diamond particles, synthetic diamond particles, or a combination of natural diamond particles and synthetic diamond particles. The first volume of unbonded particulate superabrasive material 132 may have a particle size from about 1 nm to about 30 nm (e.g., from about 2 nm to about 25 nm, from about 2 nm to about 20 nm, from about 5 nm to about 20 nm, etc.). In some embodiments the first volume of particulate superabrasive material 132 has a substantially uniform grain size (e.g. nanocrystalline grains from about 1 nm to about 20 nm, microcrystalline grains from about 1 to about 5 microns, microcrystalline grains from about 5 to about 12 microns, etc.). In other embodiments, the first volume of unbonded particulate superabrasive material 132 may comprise superabrasive particles having at least one mutually different characteristic. By way of non-limiting example, the at least one different characteristic may comprise different grain sizes. The superabrasive particles having different grain sizes may be disposed at the same or different levels into separate regions in different areas on the surface 105 of substrate 104 to form the first volume of bonded polycrystalline superabrasive material 108 that may have separate regions with different grain sizes, as described in further detail below with regard to FIGS. 11-15. Alternatively, the superabrasive particles having different grain sizes may be substantially homogeneously mixed to form, for example, a bi-modal (i.e, two different grain sizes) mix, a tri-modal (i.e., three different grain sizes) mix, etc. The first volume of particulate superabrasive particles may be placed on surface 105 of substrate 104 by, for example, additive manufacturing techniques, also characterized as direct deposition techniques and 3-D printing techniques, using an appropriate apparatus 136.

FIG. 4 illustrates depositing a carbon-containing precursor material 134 onto the first level of the first volume of unbonded particulate superabrasive material 132. One suitable carbon-containing precursor material is poly(phenylcarbyne). Another suitable carbon-containing precursor material is poly(hydridocarbyne). In some embodiments, the carbon-containing precursor material 134, if in particulate form, may be placed onto the first level of the first volume of unbonded particulate superabrasive material 132 through additive manufacturing techniques which, upon heating with an energy beam, disperses and penetrates the particulate superabrasive material. In other embodiments, the carbon-containing precursor may be in flowable (e.g., fluid) form and be dispensed to penetrate the first level of the first volume of unbonded particulate superabrasive material 132. It is desirable that substantial, if not complete, penetration of the particulate superabrasive material be achieved. In other embodiments, the carbon-containing precursor material 134 and the unbonded particulate superabrasive material 132 may be mixed together and applied as a first level, as by additive manufacturing. In certain embodiments, the first carbon-containing precursor material 134, for example poly(hydridocarbyne), may comprise amorphous carbon.

Referring now to FIG. 5, an energy beam device 138 of additive manufacturing apparatus 136 directs an energy beam 140 to scan the first carbon-containing precursor material 134 and associated first level of unbonded particulate superabrasive material 132 in a desired pattern corresponding to a selected size and shape of a first level of a superabrasive component being formed. In some embodiments, the first energy beam device 138 may comprise a laser device and the first energy beam 140 may comprise a laser beam of a power and spot size sufficient to pyrolize the precursor material, for example between about 1000° C. and about 1600° C. The heat from the energy beam may liquefy, or if already flowable, decrease viscosity of the carbon-containing precursor material 134 to penetrate spaced between particles of the first level of the first volume of unbonded particulate superabrasive material 132 and at least partially coat the particles. The heated, liquefied first carbon-containing precursor material 134 may stimulate formation of a first volume of bonded polycrystalline superabrasive material 108 having carbon-carbon atomic bonds between adjacent particles of the first level of the first volume of unbonded particulate superabrasive material 132. In some embodiments, directing the first energy beam 140 onto the first carbon-containing precursor material 134 occurs in an oxygen-free inert atmosphere. In some embodiments, the first energy beam is employed in a pyrolysis process to decompose the first carbon-containing precursor material 134 to form hybridized Sp³ bonds establishing carbon-carbon bonds between the superabrasive particles. The foregoing process may be repeated as many times, level by level, as necessary to form a desired thickness of the first volume of bonded superabrasive material having a desired internal and external geometry.

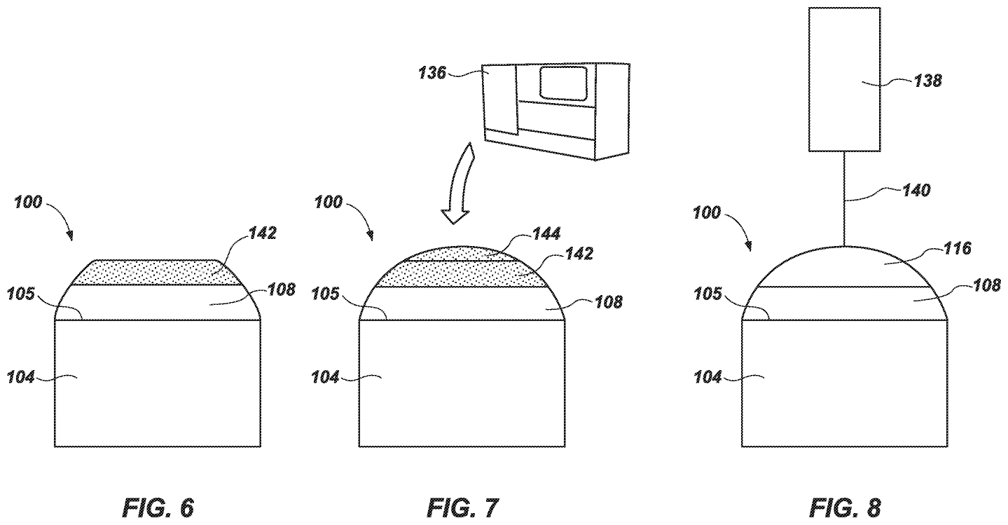

FIG. 6 illustrates disposing a first level of a second volume of unbonded particulate superabrasive material 142 on the first volume of bonded polycrystalline superabrasive material 108. In some embodiments, the second volume of unbonded particulate superabrasive material 142 may comprise particulate natural diamond particles, synthetic diamond particles, or a combination of natural diamond particles and synthetic diamond particles. The second volume of unbonded particulate superabrasive material 142 may have a particle size from about 1 nm to about 30 nm (e.g., from about 2 nm to about 25 nm, from about 2 nm to about 20 nm, from about 5 nm to about 20 nm, etc.). In some embodiments, the first volume of unbonded particulate superabrasive material 132 may be the same material as the second volume of unbonded particulate superabrasive material 142. In other embodiments the first volume of unbonded particulate superabrasive material 132 may be a different material than the second volume of unbonded particulate superabrasive material 142. In some embodiments the second volume of unbonded particulate superabrasive material 142 has a substantially uniform grain size (e.g. nanocrystalline grains from about 1 nm to about 20 nm, microcrystalline grains from about 1 to about 5 microns, microcrystalline grains from about 5 to about 12 microns, etc.). In other embodiments, the second volume of unbonded particulate superabrasive material 142 may comprise superabrasive particles having at least one mutually different characteristic. By way of nonlimiting example, the at least one different characteristic may comprise different grain sizes. In some embodiments, the first volume of unbonded particulate superabrasive material 132 may comprise a first substantially uniform grain size, and the second volume of unbonded particulate superabrasive material 142 may comprise a second substantially uniform grain size. In additional embodiments, the first substantially uniform grain size may be the same as the second substantially uniform grain size, but the binder content (i.e., volume of carbon-containing precursor material after heating) employed in the second volume may be different, resulting in a relatively greater or lesser diamond volume in each of the first and second. In other embodiments, the first substantially uniform grain size may be the different than the second substantially uniform grain size. The superabrasive particles having different grain sizes may be disposed into discrete, separate regions at various levels to form the second volume of bonded polycrystalline superabrasive material 116 that may have separate regions with different grain sizes, as described in further detail below with regard to FIGS. 11-15.

FIG. 7 illustrates depositing a second carbon-containing precursor material 144 onto the first level of the second volume of unbonded particulate superabrasive material 142. In some embodiments, the second carbon-containing precursor material 144 if in particulate form, may be placed onto the second volume of unbonded particulate superabrasive material 142 through additive manufacturing which, upon heating with an energy beam, disperses and penetrates the particulate superabrasive material. In other embodiments, the carbon-containing precursor may be in flowable (e.g., fluid) form and be dispensed to penetrate the first level of the second volume of unbonded particulate superabrasive material 142. In further embodiments, the second carbon-containing precursor material 144 and the second volume of unbonded particulate superabrasive material 142 may be mixed together. In certain embodiments, the second carbon-containing precursor material 144 may comprise amorphous carbon. In some embodiments, the second carbon-containing precursor material 144 may comprise the same material as the first carbon-containing precursor material 134. In additional embodiments the first carbon-containing precursor material 134 may be a different material than the second carbon-containing precursor material 144.

Referring now to FIG. 8, energy beam device 138 of additive manufacturing apparatus 136 directs an energy beam 140 onto the second carbon-containing precursor material 144. The heat from the energy beam 140 may liquefy, or reduce the viscosity of, the second carbon-containing precursor material 144 to penetrate spaces between particles of the first level of the second volume of unbonded particulate superabrasive material 132 and substantially coat the particles. Additionally, some of the liquefied second carbon-containing precursor material 144 may contact the uppermost level of the first volume of bonded polycrystalline superabrasive material 108 and penetrate into any interstices between the bonded particles. The liquefied second carbon-containing precursor material 144 may stimulate formation of a first level of a second volume of bonded polycrystalline superabrasive material 116 having carbon-carbon atomic bonds between adjacent particles of the second volume of unbonded particulate superabrasive material 142, as well as between particles of the first level of the second volume of unbonded particulate superabrasive material 142 and particles of the uppermost level of the first volume of bonded polycrystalline superabrasive material 108. In some embodiments, directing the energy beam device 138 onto the second carbon-containing precursor material 144 occurs in an oxygen-free inert atmosphere. In some embodiments, the energy beam 140 is employed in a pyrolysis process to decompose the second carbon-containing precursor material 144 to form hybridized Sp³ bonds establishing carbon-carbon bonds between the superabrasive particles. The foregoing process may be repeated as many times, level by level, as necessary to form a desired thickness of the second volume of bonded superabrasive material having a desired internal and external geometry.

Additional embodiments include forming multiple levels of at least one additional volume of bonded polycrystalline superabrasive material 122 onto the second volume of bonded polycrystalline material using substantially the same method as described above with regard to FIGS. 6-8. The at least one additional volume of unbonded particulate superabrasive material may include unbonded superabrasive particles and may be disposed on the uppermost level of the second volume of bonded polycrystalline superabrasive material 116. The unbonded particulate superabrasive material or materials of the at least one additional volume of particulate superabrasive material may be the same or different than the material or materials each of the first volume of unbonded particulate superabrasive material 132 and the second volume of unbonded particulate superabrasive material 142. A third carbon-containing precursor material may be deposited onto the at least one additional volume of particulate superabrasive material. The third carbon-containing precursor material may be the same or different than each of the first carbon-containing precursor material 134 and the second carbon-containing precursor material 144. The energy beam device 138 may direct an energy beam 140 onto the third carbon-containing precursor material to form the at least one additional volume of bonded polycrystalline material. In some bonded directly to particles of the second volume of bonded polycrystalline superabrasive material 116.

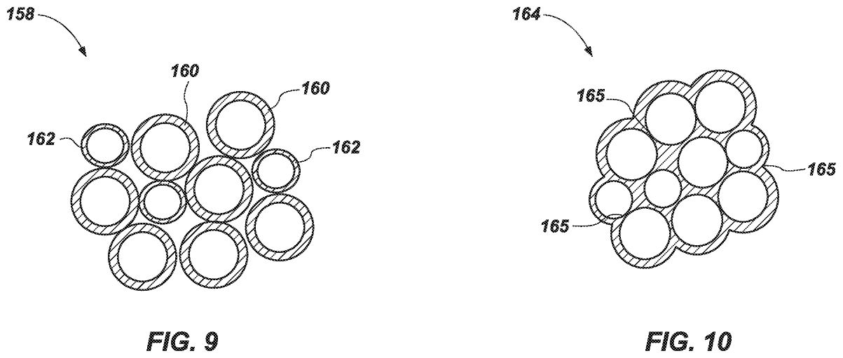

FIG. 9 is an enlarged view illustrating the microstructure of an unbonded particulate mass 158. The unbonded particulate mass 158 comprises, by way of example, a portion of a volume of unbonded particulate superabrasive material 132 combined with (i.e., coated with) the first carbon-containing precursor material 134 before directing the energy beam 140 onto the first carbon-containing precursor material 134 or before the energy beam has pyrolized the carbon-containing precursor. The volume of unbonded particulate material may correspond to a first volume, a second volume or at least one additional volume of unbonded particulate superabrasive material as described above. In some embodiments, carbon-containing precursor particles 162 are interspersed between unbonded polycrystalline superabrasive particles 160 before directing the energy beam 140 onto the first carbon-containing precursor material 134 to heat the precursor particles 162 to a flowable form to penetrate between the unbonded polycrystalline superabrasive particles 160 and stimulate formation of a volume of bonded polycrystalline superabrasive material, for example volume 108, volume 116 or the at least one additional volume. In other embodiments, carbon-containing precursor particles 162 may reside on top of the unbonded polycrystalline superabrasive particles 160 and liquefy or vaporize to penetrate spaces between the particles responsive to heating by the energy beam 140.

FIG. 10 is an enlarged view illustrating the microstructure 164 of bonded polycrystalline superabrasive particles 165. The bonded polycrystalline superabrasive particles 165 may depict the microstructure of any of the volumes of bonded polycrystalline superabrasive material 108, 116 or the at least one additional volume

FIG. 11 illustrates another embodiment of the superabrasive component 100, 100′ shown in FIG. 1 or FIG. 2. In some embodiments, the first volume of bonded polycrystalline superabrasive material 108 may have at least one characteristic (e.g. grain size) different from a characteristic of the second volume of bonded polycrystalline superabrasive material 116. For example, the first volume of bonded polycrystalline superabrasive material 108 may have large grains, whereas the second volume of bonded polycrystalline superabrasive material 116 may have small grains. A difference in grain size between the first volume of bonded polycrystalline superabrasive material 108 and the second volume of bonded polycrystalline superabrasive material 116 may affect the wear resistances and enable formation and self-sharpening of a cutting edge on a surface of the bonded polycrystalline superabrasive material 102. More specifically, the volume of bonded polycrystalline superabrasive material 108 may wear preferentially to the other volume of bonded polycrystalline superabrasive material 116 during drilling in a self-sharpening action, undercutting the second volume of bonded polycrystalline material 116 as shown in broken lines, resulting in a cutting edge E of the second volume of bonded polycrystalline superabrasive material 116 proximate the interface between the first volume of bonded polycrystalline superabrasive material 108 and the second volume of bonded polycrystalline superabrasive material 116.

FIG. 12 illustrates another embodiment of the superabrasive component 100, 100′ shown in FIGS. 1 or FIG. 2. In some embodiments, the first volume of bonded polycrystalline superabrasive material 102 may comprise a layer comprising a number of regions having at least one mutually different characteristic 166 (e.g. grain size). The regions may be organized in a plane parallel to the surface of the substrate 104 (e.g. side-by-side a horizontal direction, for example in a checkerboard pattern). The regions may also be organized in a plane perpendicular to the surface of the substrate 104 (e.g. stacked in a vertical direction). The number of regions having at least one mutually different characteristic 166 may include at least one region from a number of regions having a first characteristic 168, and at least one region from a number of regions having a second characteristic 170. By way of non-limiting example, the first volume of bonded polycrystalline superabrasive material 108 may have a number of regions having a first characteristic 168 and a number of regions having a second characteristic 170. In some embodiments, the number of regions having a first characteristic 168 and the number of regions having a second characteristic 170 may be interspersed and arranged in an ordered two-dimensional or three-dimensional array. In some embodiments, the number of regions having a first characteristic 168 may have relatively larger superabrasive grains, whereas the number of regions having a second characteristic 170 may have relatively smaller superabrasive grains. In some embodiments, the number of regions having a first characteristic 168 may comprise natural diamond, while the number of regions having a second characteristic 170 may comprise synthetic diamonds. In a further embodiments, the number of regions having a first characteristic 168 may comprise a multi-modal (e.g., bi-modal, tri-modal) mixture of different superabrasive grain sizes, while the number of regions having a second characteristic 170 may comprise a single size of superabrasive grains.

While the foregoing describes embodiments of the first volume of bonded polycrystalline superabrasive material 108, the same may apply to the second volume of bonded polycrystalline superabrasive material 116 and the at least one additional volume of bonded polycrystalline superabrasive material 122. In certain embodiments, the first volume of bonded polycrystalline superabrasive material 108 may exhibit substantially the same regions organized in substantially the same manner as the second volume of bonded polycrystalline superabrasive material 116 or the at least one additional volume of bonded polycrystalline superabrasive material 122. In other embodiments, the first volume of bonded polycrystalline superabrasive material 108 may exhibit substantially different regions organized in a substantially different manner than the second volume of bonded polycrystalline superabrasive material 116 or the at least one additional volume of bonded polycrystalline superabrasive material 122. A difference in grain size between the number of regions having a first characteristic 168 and the number of regions having a second characteristic 170 may prevent crack propagation and spalling based on the arrangement of characteristics 168 and 170.

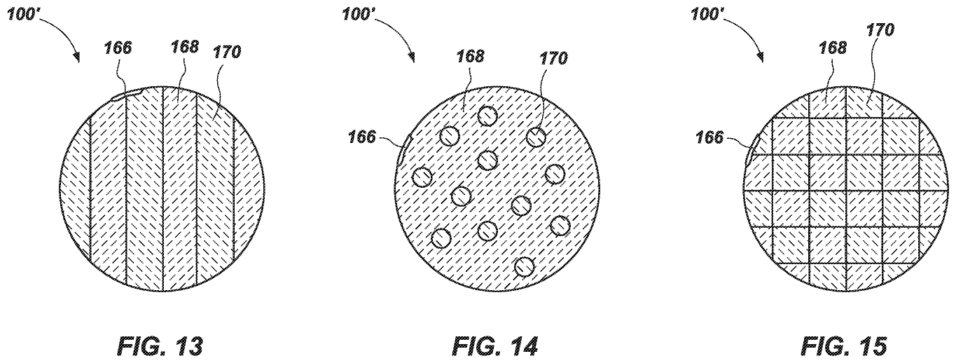

FIGS. 13-15 illustrate top cross-sectional views of variations of embodiments of the superabrasive component 100 and 100′, shown respectively in FIG. 1 and FIG. 2. Referring now to FIG. 13, the number of regions having at least one different characteristic 166 may be organized into continuous, mutually parallel regions spanning an entire length of a volume of bonded polycrystalline superabrasive material. The number of regions having a first characteristic 168 and the number of regions having a second characteristic 170 may be interspersed and arranged in an ordered array (e.g. alternating lines).

Referring now to FIG. 14, in other embodiments, the number of regions having a first characteristic 168 may be continuous and surround the number of regions having a second characteristic 170. The number of regions having a second characteristic 170 may comprise any shape (e.g. small spheres, ellipsoid, cones, cubes, pyramids, etc.) and be interspersed randomly throughout a volume of bonded polycrystalline superabrasive material 108. In other embodiments, the number of regions having a second characteristic 170 may be interspersed equidistant from one other throughout the first volume of bonded polycrystalline superabrasive material 108.

Referring now to FIG. 15, in additional embodiments, the number of regions in a volume of bonded superabrasive material having a first characteristic 168 and the number of regions having a second characteristic 170 may be interspersed and arranged in an alternate ordered array (e.g. a checkerboard).

While the foregoing describes only one volume of bonded polycrystalline superabrasive material 108, the depict non-limiting examples of cross-sectional views of the first volume of bonded polycrystalline superabrasive material 108, same may apply to the second volume of bonded polycrystalline superabrasive material 116 and the at least one additional volume of bonded polycrystalline superabrasive material 122.

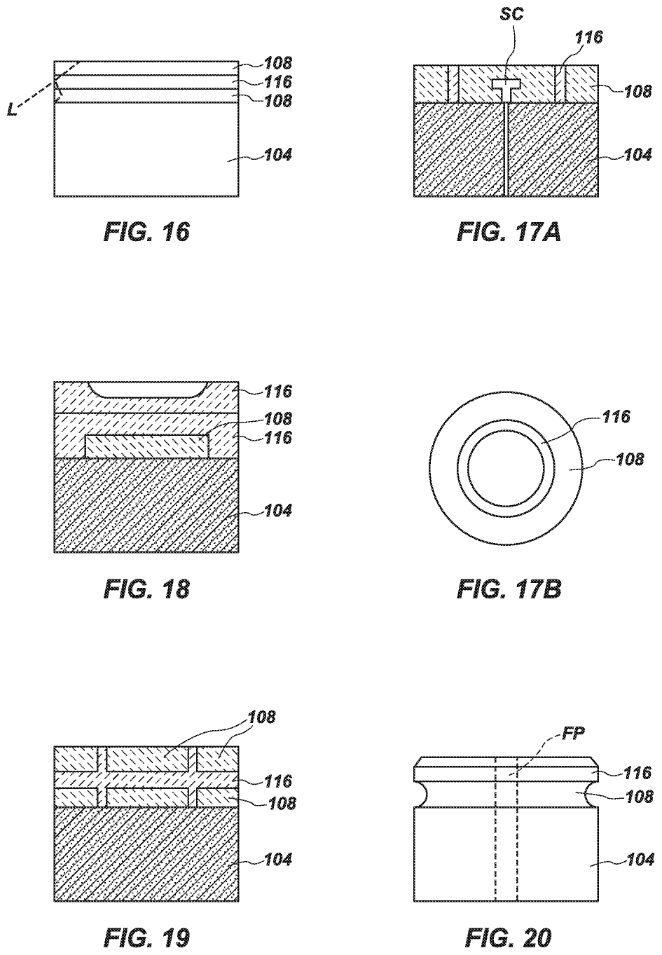

FIGS. 16 through 20 depict additional embodiments of superabrasive components in the form of PDC tables on substrates, according to the disclosure.

FIG. 16 depicts a side elevation of a cutting element comprising a substrate 104 to which is bonded a three-layer PDC table with a base layer 108 of diamond particles of a grain size, an intermediate layer of bonded polycrystalline superabrasive material 116 with diamond particles of a different grain size, and another layer of bonded polycrystalline superabrasive material 108. As shown in broken lines, the layers may wear differently, providing a cutting edge lip L in a self-sharpening action.

FIG. 17A is a side sectional elevation of a cutting element comprising a substrate 104 to which is bonded a PDC table comprising volume of bonded of bonded polycrystalline superabrasive material 108 of a grain size and binder content and a ring of bonded polycrystalline superabrasive material 116 of a different grain size and/or binder content, as well as a sensor cavity SC in the middle of the diamond table behind the cutting face. FIG. 17B is a top view of the PDC table.

FIG. 18 is a side sectional elevation of a cutting element comprising a substrate 104 to which is bonded a PDC table comprising a volume of bonded polycrystalline superabrasive material 116 of a grain size and binder content capping another volume of bonded polycrystalline superabrasive material 108 of a different grain size and/or binder content. The cutting face of the PDC table comprises another volume of bonded polycrystalline superabrasive material 116 having a recess in the cutting face.

FIG. 19 is a side sectional elevation of a cutting element comprising a substrate 104 to which is bonded a PDC table comprising a volume of bonded polycrystalline superabrasive material 108 of a grain size and binder content intersected horizontally and vertically by another volume of bonded polycrystalline superabrasive material 116of a different grain size and/or binder content, configured as a grid, which may reduce crack propagation in the diamond table and/or spalling of the diamond table.

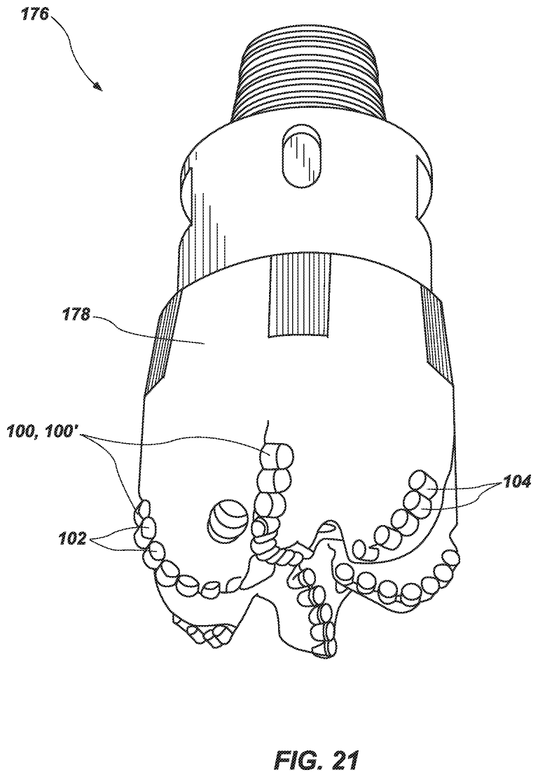

FIG. 20 is a side elevation of a cutting element comprising a substrate 104 to which is bonded a PDC table comprising a volume of bonded polycrystalline superabrasive material 108 of a grain size and binder content exhibiting a concave side surface capped with another volume of bonded polycrystalline superabrasive material 226 of a different grain size and/or binder content and having a chamfered cutting edge. The cutting element also has a fluid passage FP extending through the substrate 104 and the diamond table to and opening on, the cutting face.

Embodiments of the superabrasive component 100, 100′ may be secured to an earth-boring tool 176 and used to remove subterranean formation material in accordance with additional embodiments of the disclosure. The earth-boring tool may, for example, be a be a rotary drill bit, a percussion bit, a coring bit, an eccentric bit, a reamer tool, a milling tool, etc. As a non-limiting example, FIG. 21 illustrates a fixed-cutter, or “drag” type earth-boring tool 176 that includes superabrasive components 100. Each superabrasive component 100 may have a bonded polycrystalline superabrasive material 102 attached to a base structure in the form of a substrate 104. The superabrasive components 100 may be substantially similar to one or more of the superabrasive components 100, 100′ as previously described herein with respect to FIGS. 1, 2, and 11-15, and may be formed in accordance with one or more of the methods previously described herein with respect to FIGS. 3-8. The earth-boring tool 176 includes a bit body 178 and superabrasive components 100, 100′ that may be attached to the bit body 178. The superabrasive components 100, 100′ may, for example, be brazed, bonded, or otherwise secured, within pockets formed in an outer surface of the bit body 178. In additional embodiments, bonded polycrystalline superabrasive material 102 may be brazed or otherwise bonded directly to mounting locations formed on the bit body 178.

Embodiments of the disclosure may offer significant advantages in ease of fabrication of complex PDC table cutting face and cutting edge geometry by avoiding the need for conventional HPHT sintering of the diamond table, as well as the ability, provided by the use of additive manufacturing, to form PDC tables to a final shape in situ on a substrate or on a platen of an additive manufacturing apparatus. In addition, the use of additive manufacturing may enable formation of internally complex PDC tables having regions of different diamond grain sizes, multi-modal grain sizes, binder content, or both, in three dimensions. Such a capability allows the formation of PDC table surfaces that wear preferentially to adjacent areas during operation, creating a self-sharpening cutting edge. In addition, the ability to form internally complex PDC tables allows formation of internal barrier areas in the PDC table to arrest internal crack propagation and the potential for spalling of portions of the PDC table. Further, the ability to tailor the stiffness of different regions of the PDC table may allow for selective elasticity within the PDC table and redirection of forces responsive to formation engagement during drilling operation to maintain portions of the PDC table most proximate the cutting edge and cutting face in a compressive state. Still further, embodiments of the disclosure may allow formation of PDC tables with preformed cavities to house sensors, or to form PDC tables with integral sensors comprising, for example, doped diamond material or other materials as well as integral electrical conductors. Similarly, embodiments of the disclosure may allow the easy formation of PDC tables with one or more internal fluid passages, to deliver drilling fluid to a cutting face or to a side surface of the PDC proximate a cutting edge.

While the disclosure has been described herein with respect to certain example embodiments, those of ordinary skill in the art will recognize and appreciate that it is not so limited. Rather, many additions, deletions and modifications to the embodiments described herein may be made without departing from the scope of the disclosure as hereinafter claimed.

In addition, features from one embodiment may be combined with features of another embodiment while still being encompassed within the scope of the disclosure. Further, the disclosure has utility in drill bits having different bit profiles as well as different cutting element types.

What is claimed is:

1. A method of forming a superabrasive component for an earth-boring tool, the method comprising:
disposing a first level of a first volume of unbonded particulate superabrasive material on a surface of a base structure;
depositing a first carbon-containing precursor material onto the first level;
directing an energy beam onto the first carbon-containing precursor material to form a first level of a first volume of bonded polycrystalline superabrasive material having carbon-carbon atomic bonds between adjacent particles;
repeating the disposing, depositing and directing to form the first level of the first volume of bonded polycrystalline superabrasive material to complete the first volume of bonded polycrystalline superabrasive material;
disposing a first level of at least a second volume of unbonded particulate superabrasive material on the first volume of bonded polycrystalline superabrasive material;
depositing a second carbon-containing precursor material onto the first level of the at least a second volume of particulate superabrasive material; and
directing an energy beam onto the second carbon-containing precursor material to form a first level of at least a second volume of bonded polycrystalline superabrasive material having carbon-carbon atomic bonds between adjacent particles and to bond with carbon-carbon atomic bonds particles of the first level of the second volume of bonded polycrystalline superabrasive material to an uppermost level of the first volume of bonded polycrystalline superabrasive material; and
repeating the disposing, depositing and directing to form the first level of the second volume of bonded polycrystalline superabrasive material to complete the at least a second volume of bonded superabrasive material.

2. The method of claim 1, further comprising forming at least some levels of at least some of the first and second volumes of bonded polycrystalline superabrasive material to have different cross-sectional areas in a plane perpendicular to a longitudinal axis of the base structure.

3. The method of claim 1, further comprising selecting unbonded superabrasive particles of the first volume of unbonded particulate superabrasive material to have a first grain size, and selecting the unbonded superabrasive particles of the at least a second volume of unbonded particulate superabrasive material to have a second grain size different than the first grain size.

4. The method of claim 1, wherein forming the first volume of bonded polycrystalline superabrasive material comprises forming multiple levels each comprising a number of contiguous regions having at least one mutually different characteristic.

5. The method of claim 4, further comprising selecting the at least one mutually different characteristic to comprise at least one of grain size or binder content.

6. The method of claim 4, further comprising forming the multiple levels of the first volume to comprise a first number of regions having a first grain size and a second number of regions having a second grain size, the first number of regions and the second number of regions being interspersed and arranged in an ordered array.

7. The method of claim 1, further comprising selecting the energy beam to comprise a laser beam.

8. The method of claim 1, further comprising directing the energy beam onto the first and second carbon-containing precursor materials in an oxygen-free inert atmosphere.

9. The method of claim 1, further comprising selecting the first and second carbon-containing precursor materials to be at least one of poly(phenylcarbyne) and poly(hydridocarbyne).

10. A method of forming a PDC table for a cutting element for an earth-boring tool, the method comprising, using an additive manufacturing apparatus:
disposing a layer of unbonded particulate diamond material including unbonded diamond particles on a surface of a base structure;
depositing a carbon-containing precursor material onto the layer of unbonded particulate diamond material;
directing a laser beam onto the first carbon-containing precursor material to form a first level of bonded polycrystalline diamond material having carbon-carbon atomic bonds between adjacent particles;
disposing at least another layer of unbonded particulate diamond material on the first level of bonded polycrystalline diamond material;
depositing the carbon-containing precursor material onto at least another layer of particulate diamond material; and
directing a laser beam onto the carbon-containing precursor material to form at least a second level of bonded polycrystalline diamond material having carbon-carbon atomic bonds between adjacent particles thereof and to particles of the first level of bonded polycrystalline diamond material.

11. The method of claim 10, further comprising disposing all particles of a given layer of unbonded particulate diamond material to comprise a common size.

12. The method of claim 10, further comprising disposing particles of a given layer of unbonded particulate material to comprise at least two different sizes.

13. The method of claim 12, further comprising mixing together particles of each of the at least two different sizes.

14. The method of claim 12, wherein particles of a given size comprise at least one discrete region of particles of that size, and particles of another size of the at least two different sizes comprise at least another discrete region.

15. The method of claim 10, further comprising forming additional levels of bonded superabrasive material to define at least one of a nonplanar cutting face or a nonplanar side surface of the PDC table.

16. The method of claim 10, further comprising forming a first, second and additional levels of bonded superabrasive material having contiguous discontinuities to define at least one of an internal cavity or an internal fluid passage in the PDC table.

17. A superabrasive component for an earth-boring tool, comprising:
a substrate; and
a PDC table secured to the substrate and comprising diamond particles mutually bonded by carbon-carbon bonds;
wherein the PDC table is entirely devoid of any catalyst.

18. The superabrasive component of claim 17, wherein the PDC table comprises at least two different sizes of diamond grains.

19. The superabrasive component of claim 18, wherein diamond grains of a common size comprise a discrete region of the PDC table.

20. The superabrasive component of claim 17, wherein the PDC table comprises multiple levels of at least one of nanodiamond particles and microdiamond particles bonded together with hybridized Sp³ bonds.
